(19) United States
(12) Patent Application Publication
(10) Pub. No.: US 2002/0083152 A1
(43) Pub. Date: Jun. 27, 2002

(54) Method for facilitating a transaction involving a company with software assets

(76) Inventors: Djenana Campara, Nepean (CA); Yalcin Suer, North York (CA); Nikolai Mansurov, Nepean (CA); Sophia OhChan, Ottawa (CA)

Correspondence Address: DOWELL & DOWELL, P.C., Suite 309, 1215 Jefferson Davis Highway, Arlington, VA, 22202, US

(21) Appl. No.: 09/964,755

(22) Filed: Sep. 28, 2001

(30) Foreign Application Priority Data
Nov. 30, 2000 (RU) 20001129913

(51) Int. Cl. G06F 15/16

(52) U.S. Cl. 709/217

(57) ABSTRACT

An objective and reliable way of effecting the technical due diligence process associated with a corporate transaction uses a software analysis tool to extract information on the target entity's software assets, followed by performing at least one subsequent step in the transaction as a function of the extracted information. Also, a method of performing technical due diligence on a target entity having software assets, including providing software files to a software analysis tool and obtaining information on the target entity's software assets from the software analysis tool. Also, a method of facilitating a transaction involving an expanding entity and a target entity having software assets, including: a third party using a software analysis tool to extract information on the target entity's software assets; the third party providing the extracted information to the expanding entity; and the expanding entity performing at least one subsequent step in the transaction as a function of the information provided by the third party.

### FIELD OF THE INVENTION

The present invention relates generally to transactions involving companies with software assets and, more particularly, to performing technical due diligence on such companies.

### BACKGROUND OF THE INVENTION

A corporate transaction such as a merger or an acquisition typically involves an expanding company (say company “A”) wishing either to merge with or acquire a target company (say, company “B”). To this end, each of the two companies assembles a team of lawyers, financial officers, human resources managers and technical experts who negotiate the terms of the transaction contract.

As shown in FIG. 1, the negotiation process typically requires an evaluation of company B's financial situation, human resources and technical assets. Thus, company A's financial officers input financial questions into a financial due diligence process 102, while company B's financial officers respond with financial answers. Similarly, company A's human resources managers input human resources questions into a human resources due diligence process 104, while company B's human resources managers respond with human resources answers. Finally, company A's technical experts input technical questions into a technical due diligence process 106, while company B's technical experts respond with technical answers. The answers obtained from the financial, human resources and technical due diligence processes 102, 104, 106 are input to the negotiation process 108 where the lawyers from the two companies finalize the terms of the transaction contract.

When company B is a software-based company, a majority of its worth or potential worth might not reside in its human resources or its financial assets (for instance, when the company is not even generating revenue). Instead, the company B's true value or competitive advantage might hinge on its technical assets, which may consist of a software product 110 such as a collection of software files stored on a jealously guarded computer. Thus, it should be appreciated that among the various due diligence processes, the technical one is of particular importance when company B is a software-based company, as the information disclosed can have a profound impact on the terms of the transaction contract. For instance, the identification of a particular individual as a key software developer may result in a clause whereby that developer is required to sign an extended contract with the newly formed company. In other cases, a realization that much of the software was written in an obscure programming language may raise issues regarding retraining of personnel, and so on.

Strangely, despite the heavy reliance placed upon information disclosed during a traditional technical due diligence process, an expanding company such as company A usually takes only limited measures aimed at establishing the reliability of this information. In fact, it is not unusual for company A to simply “trust” company B in respect of the accuracy of information relating to copyright issues, the identity of key software designers, the usage of or dependence on third party software, the extent to which various programming languages are employed and even the overall software quality.

For any of a number of reasons, therefore, company B may be tempted to offer false or misleading information in the course of the technical due diligence process 108. This places company A at risk, since it is often the case that the veracity of the information can only be tested after integration of the two companies, at which point huge investments may already have been made and any number of undesirable scenarios may be under way. For instance, the chief executives of what was formerly company B (prior to the transaction) may have disappeared with funds derived from the completed merger or acquisition. In other cases, severe complications, such as a tarnished corporate image or a loss of market share, can arise even if the information is incorrect through no malicious intent of the target company.

To reduce the risks associated with technology transfer, one of the safeguards that company A has against misrepresentations made by company B during the technical due diligence process is in the form of including strong language in the transaction contract, which could provide for lawsuits against those who offer false or misleading statements. However, such a mechanism is not only adversarial in nature and thus counterproductive to the negotiation process, but is often futile in restoring all of company A's image, market share and financial position that may have been damaged as a direct or indirect consequence of inaccurate statements made during the technical due diligence process 106.

### SUMMARY OF THE INVENTION

The present invention provides a more objective and reliable way of effecting the technical due diligence process than what is performed in the prior art. Specifically, it involves running a software analysis tool on the software assets of a target company, resulting in the generation of information about the target company's software assets. This information can then be relied upon to make more informed decisions at other levels of the negotiation process. The expanding company need not actually be given access to the software assets of the target company, as the software analysis tool could be run by a third party which merely acts as a supplier of technical due diligence information to the expanding company and which has signed a non-disclosure agreement with the target company.

Therefore, the invention may be summarized according to a first broad aspect as a method of facilitating a transaction involving a target entity having software assets, including using a software analysis tool to extract information on the target entity's software assets and performing at least one subsequent step in the transaction as a function of the extracted information.

The invention may also be summarized according to a second broad aspect as a method of performing technical due diligence on a target entity having software assets, including providing software files to a software analysis tool and obtaining information on the target entity's software assets from the software analysis tool.

According to a third broad aspect, the invention may be summarized as a method of facilitating a transaction involving an expanding entity and a target entity having software assets, including: a third party using a software analysis tool to extract information on the target entity's software assets; the third party providing the extracted information to the expanding entity; and the expanding entity performing at least one subsequent step in the transaction as a function of the information provided by the third party.

These and other aspects and features of the present invention will now become apparent to those of ordinary skill in the art upon review of the following description of specific embodiments of the invention in conjunction with the accompanying drawings.

### BRIEF DESCRIPTION OF THE DRAWINGS

In the drawings:

FIG. 1 shows steps in a typical transaction involving an expanding company and a target company;

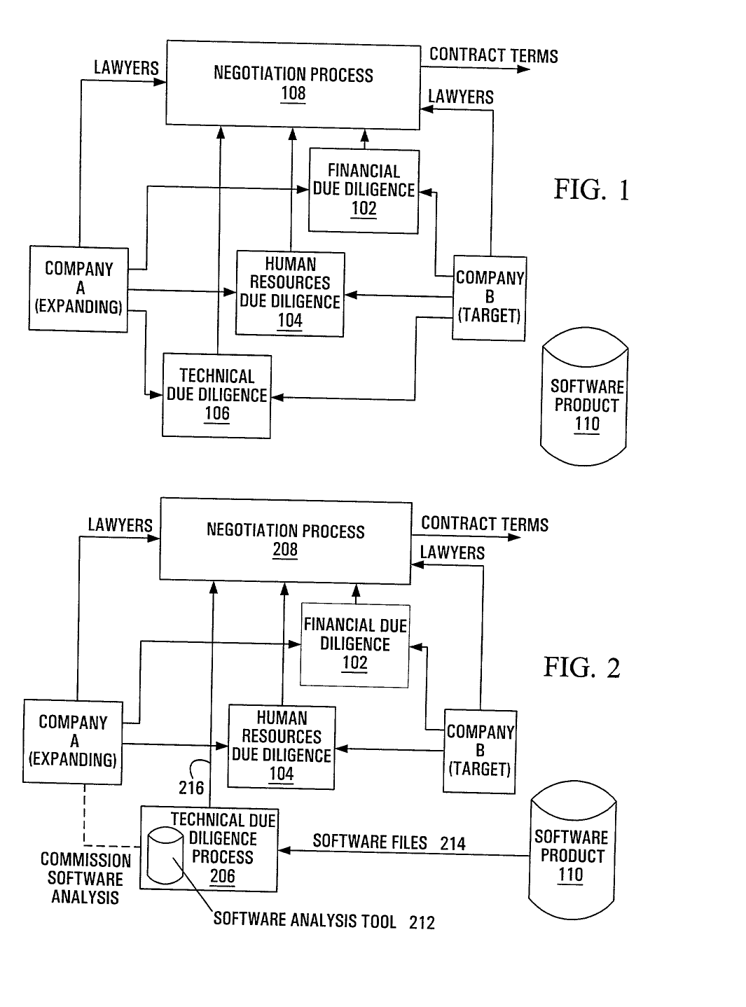

FIG. 2 shows steps in a transaction wherein the technical due diligence stage has been modified in accordance with an embodiment of the present invention; and

FIGS. 3A-3E show various instantiations of the software analysis tool and various examples of the information which can be produced by the software analysis tool.

### DETAILED DESCRIPTION OF THE PREFERRED EMBODIMENTS

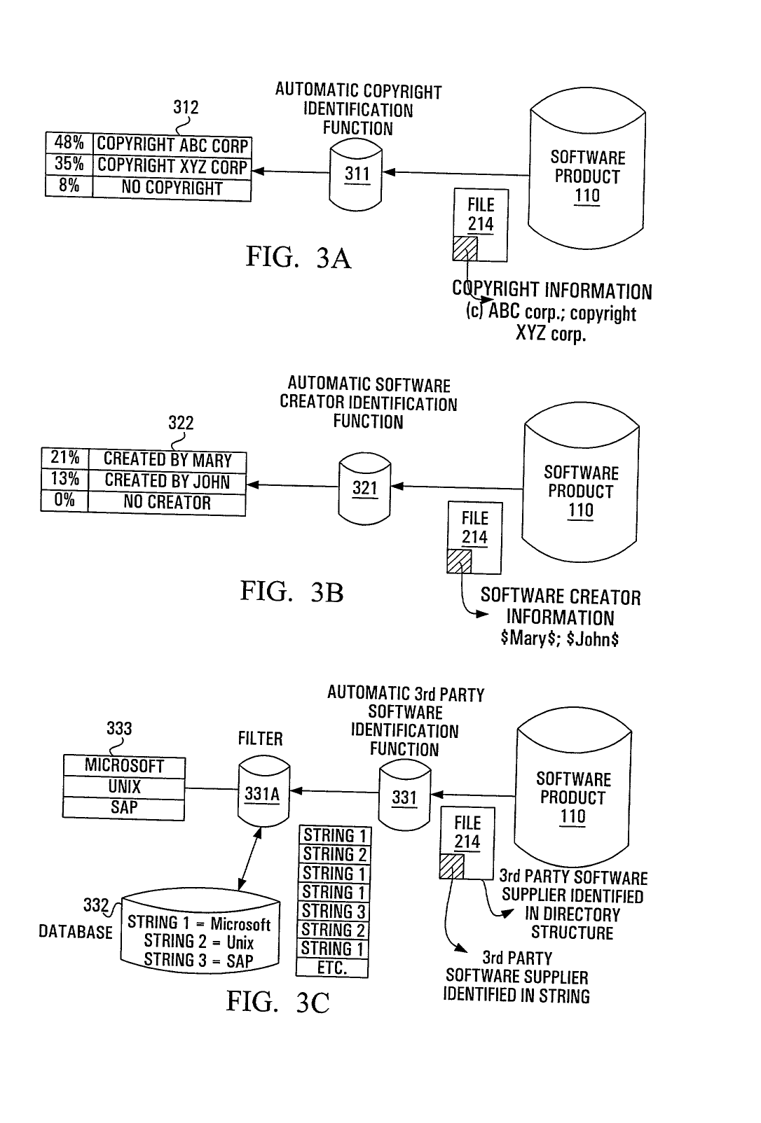

FIG. 2 shows various stages of a transaction wherein the technical due diligence process is effected in accordance with an embodiment of the present invention. As with a traditional corporate transaction, the results of a financial due diligence process 102, a human resources due diligence process 104 and a technical due diligence process 206 are input to a negotiation process 208. However, the technical due diligence process 206 of the present invention differs considerably from a traditional technical due diligence process 106 in that it produces more objective and reliable information about company B's technical assets, namely software product 110. Specifically, the technical due diligence process 206 of the present invention includes running a software analysis tool 212 on company B's software product 110.

The software analysis tool 212 may itself be embodied as software. Its inputs are software files 214 forming part of the company B's software product 110. Its outputs are technical due diligence information 216 which includes, but is not limited to, information on copyright, on the creators of the software files 214, on the extent to which various kinds of third party software is used, on the extent to which various programming languages are used, on the extent to which various file formats are used, and a high-level assessment of the software quality.

The software analysis tool 212 therefore requires access to company B's software files 214. However, in some cases, company B may be reluctant to offer company A access to its jealously guarded software assets. If this situation should arise, a third party could be commissioned by company A to perform the software analysis; alternatively, the third party could be contracted by company B. The third party, referred to as a software evaluator, could sign a non-disclosure agreement with company B and thus gain access to its software files 214 while eliminating the risk that company A will gain a competitive advantage from this operation. Thus, the software evaluator could access the software files 214 of company B, run the software analysis tool 212 and input only the results of the analysis to the negotiation process 208, without company A ever having access to company B's software product 110.

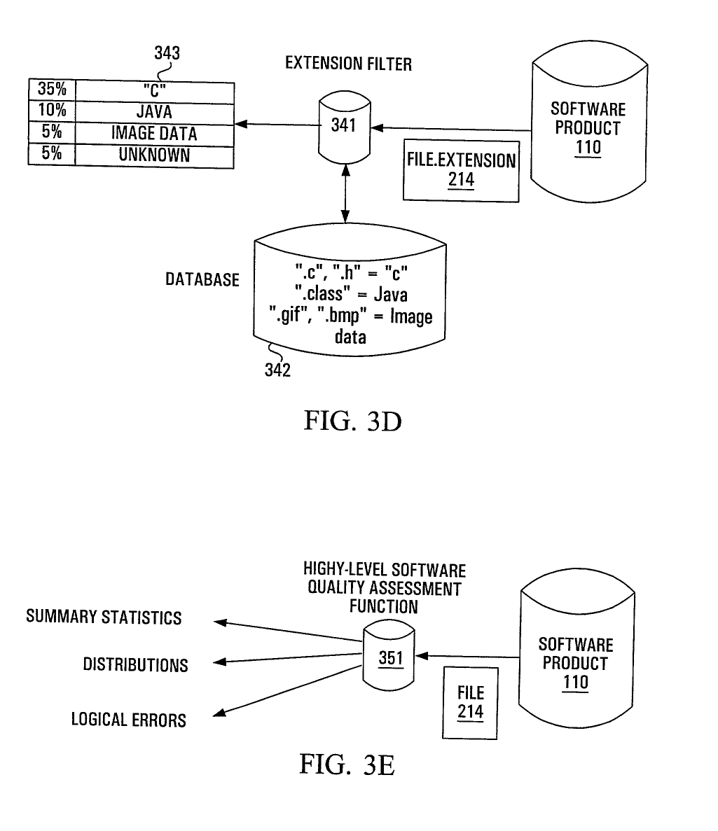

The software analysis tool 212 and the information 216 it provides can take on many forms, examples of which are now described with reference to FIGS. 3A-3E.

With reference to FIG. 3A, the software analysis tool is embodied as an automatic copyright identification function (ACIF) 311. The inputs to the ACIF 311 are software files 214 such as source files, some of which may contain the identity of a copyright owner (e.g., “ABC corp.” or “XYZ corp.”) preceded by the expression “©”, “(c)” or “copyright”. Thus, the ACIF could be a script (e.g., in the “c” language) which implements a searching function that searches for “©”, “(c)” or “copyright” and stores the data appearing thereafter.

The ACIF 311 could also implement a tabulating function which tabulates the results of the searching function in terms of the percentage of files having a particular copyright owner identified by the searching function. Thus, the output of the ACIF 311 could be a table 312 listing the copyright owner and the percentage of files in which that owner has a copyright. The tabulating function could also be adapted to produce an entry in the table 312 which indicates the percentage of files that have no copyright owner.

The copyright information produced by the ACIF 311 may significantly affect the negotiation process 208 as it may raise questions regarding the existence of licenses from the copyright owners, or it may force company B to explain why a certain percentage of files do not have an identified copyright owner (for instance, is it because there is no owner, because the owner is unknown or because company B wishes the owner to remain anonymous?)

With reference to FIG. 3B, the software analysis tool 212 is embodied as an automatic software creator identification function (ASCIF) 321. The inputs to the ASCIF 321 are software files 214 such as source files or configuration management files associated with the source files. Each source file typically contains the identity of the person who created the file (e.g., John or Mary). Each configuration management file associated with a source file typically contains the entire history of that source file, including the identity of those individuals responsible for creating each revision of the file. Typically, software creator information is embedded in a specially marked string, e.g., surrounded by “$” characters, in the file body or in a comment. Thus, the ASCIF 321 could be a “c” language script which implements a searching function that searches for “$” characters and stores the identity of the software creator appearing between two such characters. Of course, there are myriad other ways of embedding software creator information in a file as well as many corresponding approaches to extracting this information and any such approach is suitable for use with the present invention.

The ASCIF 321 could also implement a tabulating function which tabulates the results of the searching function in terms of the percentage of files created by a particular software creator identified by the searching function. Thus, the output of the ASCIF 321 could be a table 322 listing the software creator and the percentage of software files created by that creator. The tabulating function could also be adapted to produce an entry in the table 322 which shows the percentage of files which have no specific creator.

The information about software creators, as produced by the ASCIF 321, may significantly affect the negotiation process 208 as it may identify specific personnel whose continued involvement with the new company would be highly desirable. In other cases, the information provided by the ASCIF 321 may prompt company A to query the identity of those individuals who have created software files that are associated with no apparent creator.

With reference to FIG. 3C, the software analysis tool 212 is embodied as an automatic third party software identification function (ATPSIF) 331. The inputs to the ATPSIF 331 are software files 214 such as source files. Each file 214 may be the property of a third party software company, such as a supplier of software tools, drivers or operating systems (e.g., Microsoft, Sun Microsystems, SAP, etc.). This information can be embedded in the directory path in which the file is located or in a string such as “#include Microsoft®.h”. Thus, the ATPSIF 331 could be a “c” language script which implements a searching function that searches for strings or directory structures indicative of non-native software files.

The ATPSIF 331 also implements a filter 331A which has access to a database 332 of third party software and its possible strings and directory structures within a host system. The filtering operation performed by the filter 331A may consist of comparing the strings or directory structures with those in the database 332 in order to determine which third party software is employed by the system hosting company B's software files 214. Thus, the output of the filter 331A could be a table 333 listing third party software suppliers and may include an entry specifying the percentage of third party software whose source is unknown or unidentified.

The information about third party software produced by the ATPSIF 331 and the filter 331A may significantly affect the negotiation process 208 as it may identify those companies with which a strong business relationship is required. This information can also be used to identify potential sources of conflict of interest or to estimate the amount of reliance that is placed on outside software suppliers and hence the actual investment made by the target company in developing its software product 110. The information produced by the ATPSIF 331 and the filter 331A could also be used to identify unusual mixes of software, which may raise compatibility concerns.

With reference to FIG. 3D, the software analysis tool 212 is embodied as an extension filter 341 which could be a “c” language script. The inputs to the filter 341 are software files 214 having various extensions (such as “.c”, “.h”, “.class”, “.html”, “.gif”, “.bmp”, etc.). Each extension has a standard meaning in the software art. For instance, “.c” and “.h” files are used in the “c” programming language, “.class” is used in the Java programming language, “.html” is the standard extension for the hypertext mark-up language, “.gif” and “.bmp” denote image files, and so on. The filter 341 has access to a database 342 which classifies the extensions according to their format or programming language.

Thus, the filter 341 compares the extensions of the software files 214 with those in the database 312 in order to determine the format or programming language associated with each file 214. The output of the filter 341 could therefore be a table 343 listing formats and programming languages and may include an entry specifying what percentage of the files 214 are in an unidentified format or programming language.

The information on formats and programming languages produced by the filter 341 may significantly affect the negotiation process 208. For example, the software analysis tool 212 of FIG. 3D will permit the detection of poor programming practice by pointing out the percentage of files in an unknown programming language or format. In another specific example, consider the case where the target company claims to be an e-commerce company, but the table 343 reveals that 1% of files 214 are in the “c language” and 99% are “image data” files. This may prompt company A to query whether company B is truly the e-commerce company it claims to be or is merely a mock-up Web site used for obtaining credit card numbers.

With reference to FIG. 3E, the software analysis tool 212 is embodied as a high-level software quality assessment function (HLSQAF) 351, which can be implemented as a “c” language script. The inputs to the HLSQAF 351 can be source files 214. On the basis of the source code in the source files 214, the HLSQAF 351 provides summary statistics, computes distributions and identifies logical errors. An example of summary statistics commonly used in the art include the number of lines of code, the number of files and the number of files per programming language (which could also be obtained from the extension filter 341 in the software evaluation tool of FIG. 3D). Popular distributions used in the art include the McCabe complexity, the testability index and the maintainability index. As far as logical errors are concerned, a program such as “lint” in Unix could be used.

If such information were requested of company B in a traditional due diligence process 106, company A would have no assurance as to its accuracy. However, by running a software evaluation tool 212 directly on company B's software files 214 in the course of the technical due diligence process 206, company A is provided with an overall picture of company B's software assets in the context of well known metrics and such information may again alter the negotiation process. For example, the results of the HLSQAF 351 could indicate the stage of development of company B's software. Also, the insight gained into company B using the HLSQAF 351 is particularly valuable when the results obtained for company B are compared with those obtained for other companies with which company A may previously have dealt with.

Of course, a combination of any or all of the above-described embodiments of the software analysis tool are within the scope of the invention, as are other software analysis tools that have not been explicitly described but which also serve to extract useful, objective and reliable information from the target company's software. Examples of a suitable software analysis tools which could be employed within the scope of the present invention are described in several U.S. Patent applications, including those with Ser. No. 09/090,954 to Rajala et al. (filed Jun. 5, 1998, now U.S. Pat. No. 6,205,576, issued Mar. 20, 2001), Ser. No. 09/181,824 to Campara et al. (filed Oct. 29, 1998, now U.S. Pat. No. 6,233,729, issued May 15, 2001) and Ser. No. 09/220,859 to Mansurov et al. (filed Dec. 28, 1998), each of which is assigned to the assignee of the present invention and hereby incorporated by reference herein in its entirety.

Furthermore, the manner of effecting technical due diligence on a target entity in accordance with the present invention is not limited to the use of the above-described types of information. In fact, the use of any type of information which can be extracted from a target entity's software product is within the scope of the invention. Those skilled in the art of software design will be familiar with the writing of scripts, functions and executables for extracting this information.

Moreover, although the word “company” has been used at various places in the above description, it should be understood that the present invention could be used to facilitate a transaction involving any entity having software assets, and such an entity could include public corporations, private corporations, partnerships, non-profit organizations, governmental organizations, non-governmental organizations, quasi-governmental organizations, departments, etc.

It should further be understood that it is within the scope of the invention to run the software analysis tool on files other than source files. For example, information that could influence the negotiation process could be extracted from source files, object files, executable files, assembler files, header files, configuration management files, library files, etc., and the extraction and compilation of any such information using a software tool in the course of a transaction would remain within the scope of the present invention.

In addition, in the case where a third party “software evaluator” is relied upon to run the software analysis tool 212 on the software files 214 of company B, it should be understood that the software evaluator need not physically displace itself to perform the task. For instance, the software evaluator could be a Web-based company that allows the software evaluation tool 212 to be downloaded by company B, possibly for a fee and possibly with an expiry date on that particular instantiation of the software. Alternatively, it is possible to run the software evaluation tool 212 online, although this may pose greater security concerns than a downloadable version.

Those skilled in the art should appreciate that in some embodiments of the invention, all or part of the functionality previously described herein with respect to the software analysis tool 212 may be implemented as pre-programmed hardware or firmware elements (e.g., application specific integrated circuits (ASICs), electrically erasable programmable read-only memories (EEPROMs), etc.), or other related components.

In other embodiments of the invention, all or part of the functionality previously described herein with respect to the software analysis tool 212 may be implemented as software consisting of a series of instructions for execution by a computer system. The series of instructions could be stored on a medium which is fixed, tangible and readable directly by the computer system, (e.g., removable diskette, CD-ROM, ROM, or fixed disk), or the instructions could be stored remotely but transmittable to the computer system via a modem or other interface device (e.g., a communications adapter) connected to a network over a transmission medium. The transmission medium may be either a tangible medium (e.g., optical or analog communications lines) or a medium implemented using wireless techniques (e.g., microwave, infrared or other transmission schemes). Moreover, the series of instructions may be written in a number of programming languages for use with many computer architectures or operating systems. For example, some embodiments may be implemented in a procedural programming language (e.g., “C”) or an object oriented programming language (e.g., “C++” or Java).

While specific embodiments of the present invention have been described and illustrated, it will be apparent to those skilled in the art that numerous modifications and variations can be made without departing from the scope of the invention as defined in the appended claims.

We claim:

1. A method of facilitating a transaction involving a target entity having software assets, comprising:
using a software analysis tool to extract information on the target entity's software assets; and
performing at least one subsequent step in the transaction as a function of the extracted information.

2. A method as claimed in claim 1, wherein the information includes copyright information.

3. A method as claimed in claim 1, wherein the information includes software owner information.

4. A method as claimed in claim 1, wherein the information includes third party software information.

5. A method as claimed in claim 1, wherein the information includes programming language information.

6. A method as claimed in claim 1, wherein the information includes a high-level quality assessment of the software assets.

7. A method as claimed in claim 1, wherein using a software analysis tool comprises:
providing software files to the software analysis tool; and
obtaining said information from the software analysis tool.

8. A method as claimed in claim 7, wherein the software files include source files.

9. A method as claimed in claim 7, wherein the software files include object files.

10. A method as claimed in claim 7, wherein the information includes a list of entities having copyright in at least one of the software files.

11. A method as claimed in claim 7, wherein the information includes a list of entities and the proportion of the software files in which each of said entities has copyright.

12. A method as claimed in claim 7, wherein the information includes the proportion of the software files in which no entity has copyright.

13. A method as claimed in claim 7, wherein the information includes the proportion of the software files in which at least one entity has copyright.

14. A method as claimed in claim 7, wherein the information includes a list of creators having created at least one of the software files.

15. A method as claimed in claim 7, wherein the information includes a list of creators and the proportion of the software files created by each of said creators.

16. A method as claimed in claim 7, wherein the information includes the proportion of the software files not specified as being created by any creator.

17. A method as claimed in claim 7, wherein the information includes the proportion of the software files specified as being created by at least one creator.

18. A method as claimed in claim 7, wherein the information includes a list of third party software vendors whose products are needed by at least one of the software files.

19. A method as claimed in claim 7, wherein the information includes a list of third party software vendors whose operating systems are needed by at least one of the software files.

20. A method as claimed in claim 7, wherein the information includes a list of third party software vendors whose software tools are needed by at least one of the software files.

21. A method as claimed in claim 7, wherein the information includes a list of programming languages and the proportion of the software files programmed in each of said programming languages.

22. A method as claimed in claim 7, wherein the information includes a list of file formats and the proportion of the software files in each of said file formats.

23. A method as claimed in claim 7, wherein using a software analysis tool further comprises:
running the software analysis tool on the software files.

24. A method of performing technical due diligence on a target entity having software assets, comprising:
providing software files to a software analysis tool; and
obtaining information on the target entity's software assets from the software analysis tool.

25. A method as claimed in claim 24, wherein the information includes copyright information.

26. A method as claimed in claim 24, wherein the information includes software owner information.

27. A method as claimed in claim 24, wherein the information includes third party software information.

28. A method as claimed in claim 24, wherein the information includes programming language information.

29. A method as claimed in claim 24, wherein the information includes a high-level quality assessment of the software assets.

30. A method as claimed in claim 24, wherein the software files include source files.

31. A method as claimed in claim 24, wherein the software files include object files.

32. A method as claimed in claim 29, wherein the information includes a list of entities having copyright in at least one of the software files.

33. A method as claimed in claim 29, wherein the information includes a list of entities and the proportion of the software files in which each of said entities has copyright.

34. A method as claimed in claim 29, wherein the information includes the proportion of the software files in which no entity has copyright.

35. A method as claimed in claim 29, wherein the information includes the proportion of the software files in which at least one entity has copyright.

36. A method as claimed in claim 29, wherein the information includes a list of creators having created at least one of the software files.

37. A method as claimed in claim 29, wherein the information includes a list of creators and the proportion of the software files created by each of said creators.

38. A method as claimed in claim 29, wherein the information includes the proportion of the software files not specified as being created by any creator.

39. A method as claimed in claim 29, wherein the information includes the proportion of the software files specified as being created by at least one creator.

40. A method as claimed in claim 29, wherein the information includes a list of third party software vendors whose products are needed by at least one of the software files.

41. A method as claimed in claim 29, wherein the information includes a list of third party software vendors whose operating systems are needed by at least one of the software files.

42. A method as claimed in claim 29, wherein the information includes a list of third party software vendors whose software tools are needed by at least one of the software files.

43. A method as claimed in claim 29, wherein the information includes a list of programming languages and the proportion of the software files programmed in each of said programming languages.

44. A method as claimed in claim 29, wherein the information includes a list of file formats and the proportion of the software files in each of said file formats.

45. A method as claimed in claim 29, further comprising:
running the software analysis tool on the software files.

46. A method of facilitating a transaction involving an expanding entity and a target entity having software assets, comprising:
a third party using a software analysis tool to extract information on the target entity's software assets;
the third party providing the extracted information to the expanding entity; and
the expanding entity performing at least one subsequent step in the transaction as a function of the information provided by the third party.

47. A method as claimed in claim 46, wherein the third party is contracted by the expanding entity.

48. A method as claimed in claim 46, wherein the third party is contracted by the target entity.
